(19) United States
(12) Patent Application Publication
(10) Pub. No.: US 2024/0291330 A1
(43) Pub. Date: Aug. 29, 2024

(54) SWITCHED RELUCTANCE MOTOR

(71) Applicant: ENEDYM INC., Hamilton (CA)

(72) Inventors: Ehab Sayed, Hamilton (CA); Berker Bilgin, Hamilton (CA)

(21) Appl. No.: 18/426,278

(22) Filed: Jan. 29, 2024

Related U.S. Application Data
(60) Provisional application No. 63/448,066, filed on Feb. 24, 2023.

(51) Int. Cl. H02K 1/14; H02K 1/16

(52) U.S. Cl. CPC H02K 1/146; H02K 1/16; H02K 2201/06; H02K 2213/03

(57) ABSTRACT

A switched reluctance motor. The motor includes a first member having a plurality of teeth arranged in a plurality of phase groups, each phase group including two teeth mechanically joined together through a magnetically permeable bridge. The motor also includes a second member mounted adjacent the first member allowing relative movement between the first and second members, the second member having a plurality of teeth evenly spaced from one another by a pitch in a direction of relative movement between the first and second members. Each phase group includes a first tooth and a second tooth which is separated from the first tooth by a phase group tooth spacing in the direction of relative movement between the first and second members, the phase group tooth spacing equal to a whole multiple of the pitch plus a skewing factor or a whole multiple of the pitch minus the skewing factor.

### CROSS REFERENCE TO RELATED APPLICATIONS

This application claims the benefit of U.S. Provisional Application Ser. No. 63/448,066, filed Feb. 24, 2023, which is hereby incorporated herein in its entirety by reference.

### FIELD

The specification relates generally to motors, and, more specifically, to switched reluctance motors.

### BACKGROUND

U.S. Pat. No. 4,883,999 to Hendershot (“Hendershot”) purports to disclose first and second members of a motor mounted for relative movement. Hendershot purports to disclose that the first member includes unevenly spaced poles, whereas the second member includes evenly spaced poles. Hendershot purports to disclose that the poles of the first member are grouped into pairs separated by a space related to the even spacing of the poles on the second member. Hendershot purports to disclose that adjacent pairs of poles on the first member are separated by a spacing which is not equal to the spacing between the poles of a pair. Hendershot purports to disclose that to provide for relative movement of the first and second members, each pair of poles on the first member are polarized to form poles of opposite polarity such that a magnetic circuit is formed joining the two adjacent poles of the pair.

U.S. Pat. No. 5,015,903 to Hancock et al. (“Hancock”) purports to disclose a stator including unevenly spaced poles which are grouped into pairs separated by a space related to the even spacing of the poles on a rotor. Hancock purports to disclose that adjacent pairs of poles on the stator are separated by a spacing which is not equal to the spacing between the poles of a pair. Hancock purports to disclose that to provide for rotation of the rotor, each pair of poles on the stator is polarized to form poles of opposite polarity such that a magnetic circuit joins the two adjacent poles of the pair. Hancock purports to disclose that magnetic circuits linking different pairs of stator poles, which are the source of flux reversals and high switching frequencies in conventional motors, are prevented by providing a stator construction that is without low reluctance paths between adjacent pairs of stator poles.

### SUMMARY

The following summary is intended to introduce the reader to various aspects of the applicant's teaching, but not to define any invention.

According to some aspects, there is provided a switched reluctance motor, comprising a stator having a plurality of stator teeth arranged in a plurality of phase groups, each phase group including two adjacent teeth mechanically joined together through a magnetically permeable bridge; and a rotor rotatably mounted within the stator and having a plurality of rotor teeth evenly spaced circumferentially by a pitch angle, and wherein each phase group includes a first tooth and a second tooth separated from the first tooth by a separation angle in a direction of rotation of the rotor, the separation angle equal to the pitch angle plus a circumferential skewing angle or the pitch angle minus the circumferential skewing angle.

In some embodiments, the circumferential skewing angle is between 0.01 times the pitch angle and 0.25 times the pitch angle.

In some embodiments, the circumferential skewing angle is between 0.05 times the pitch angle and 0.15 times the pitch angle.

In some embodiments, a tooth geometry of the first tooth is different from a tooth geometry of the second tooth.

In some embodiments, the magnetically permeable bridges are bridge segments of a circumferentially continuous yoke of the stator and adjacent bridge segments are mechanically joined together by intermediate segments, the intermediate segments having a first radial thickness of magnetically permeable material and the bridge segments having a second radial thickness of magnetically permeable material, the second radial thickness being greater than the first radial thickness.

In some embodiments, the yoke includes recesses on a radial outer surface between bridge segments.

According to some aspects, there is provided a switched reluctance motor, comprising a first member having a plurality of teeth arranged in a plurality of phase groups, each phase group including two teeth mechanically joined together through a magnetically permeable bridge; and a second member mounted adjacent the first member allowing relative movement between the first and second members, the second member having a plurality of teeth evenly spaced from one another by a pitch in a direction of relative movement between the first and second members, and wherein each phase group includes a first tooth and a second tooth which is separated from the first tooth by a phase group tooth spacing in the direction of relative movement between the first and second members, the phase group tooth spacing equal to a whole multiple of the pitch plus a skewing factor or a whole multiple of the pitch minus the skewing factor.

In some embodiments, the whole multiple is a single multiple and the first tooth and the second tooth are adjacent teeth.

In some embodiments, the skewing factor is between 0.05 times the pitch and 0.15 times the pitch.

In some embodiments, the skewing factor is between 0.01 times the pitch and 0.25 times the pitch.

In some embodiments, the first member is a stator, and the second member is a rotor rotatably mounted within the stator.

In some embodiments, each tooth of each phase group is part of a pair, the pair including another tooth separated by a whole multiple of the pitch plus a skewing factor or a whole multiple of the pitch minus the skewing factor.

In some embodiments, the two teeth mechanically joined together through the magnetically permeable bridge includes the first tooth and the second tooth.

According to some aspects, there is provided a switched reluctance motor, comprising a first member having a plurality of teeth arranged in a plurality of phase groups, each phase group including two teeth mechanically joined together through a magnetically permeable bridge; and a second member mounted adjacent to the first member allowing relative movement between the first and second members, the second member having a plurality of teeth evenly spaced from one another by a pitch in a direction of relative movement between the first and second members, and wherein a phase group of the plurality of phase groups includes teeth of differing geometries.

In some embodiments, the first member is a stator, and the second member is a rotor rotatably mounted within the stator, and the pitch is a rotor pitch angle.

In some embodiments, each phase group includes teeth of differing geometries.

In some embodiments, the teeth of differing geometries are adjacent teeth.

In some embodiments, the phase group includes a first tooth and a second tooth, and a circumferential width of an inner end of a core of the first tooth is different from a circumferential width of an inner end of a core of the second tooth.

In some embodiments, the circumferential width of the inner end of a core of the second tooth is greater than the circumferential width of the inner end of a core of the first tooth.

In some embodiments, the phase group includes a first tooth with a core having a first radial extent and a second tooth with a core having a second radial extent that is greater than the first radial extent.

According to some aspects, there is provided a switched reluctance motor, comprising a first member having a plurality of teeth extending from a first side of the first member, the plurality of teeth arranged in a plurality of phase groups, each phase group including two teeth mechanically joined together through a magnetically permeable bridge, the magnetically permeable bridges forming bridge segments of a continuous back portion of the first member, and adjacent bridge segments mechanically joined together by intermediate segments; and a second member mounted adjacent the first member allowing relative movement between the first and second members, the second member having a plurality of teeth evenly spaced from one another by a pitch in a direction of relative movement between the first and second members, and wherein the intermediate segments have a first thickness of magnetically permeable material and the bridge segments have a second thickness of magnetically permeable material, the second thickness being greater than the first thickness whereby a surface of the continuous back portion of the first member includes recesses between bridge segments, the recesses arranged at a second side of the first member opposite the first side from which the plurality of teeth extend.

In some examples, the first member is a stator and the second member is a rotor rotatably mounted within the stator, and the continuous back member is a continuous yoke, and the first side of the first member is an inner side and the second side of the first member is an outer side.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of a first switched reluctance motor having evenly spaced stator teeth;

FIG. 2 is a perspective view of a second switched reluctance motor having additional stator teeth;

FIG. 3 is a schematic diagram of a first set of flux paths through a third switched reluctance motor;

FIG. 4 is a schematic diagram of a second set of flux paths through the switched reluctance motor of FIG. 3;

FIG. 5 is a perspective view of a fourth switched reluctance motor having smaller areas of low flux density;

FIG. 6 is a perspective view of a fifth switched reluctance motor having areas of low flux density removed;

FIG. 7 is a side view of a portion of the switched reluctance motor of FIG. 2;

FIG. 8 is a side view of a portion of sixth switched reluctance motor having a counterclockwise skewed tooth;

FIG. 9 is a side view of a portion of seventh switched reluctance motor having a clockwise skewed tooth;

FIG. 10 is a side view of a portion of eight switched reluctance motor having stator teeth of the same geometry;

FIG. 11 is a side view of a portion of ninth switched reluctance motor having stator teeth with different widths;

FIG. 12 is a side view of a portion of tenth switched reluctance motor having stator teeth of different heights;

FIG. 13 is a perspective view of a portion of an eleventh switched reluctance motor having teeth with a negative taper angle;

FIG. 14 is a side view of a twelfth switched reluctance motor without skewing;

FIG. 15 is a side view of a thirteenth switched reluctance motor with skewing;

FIG. 16 is a graph comparing torque ripple of the switched reluctance motors of FIGS. 14 and 15 compared to the torque ripple of a further switched reluctance motor;

FIG. 17 is a side view of a fourteenth switched reluctance motor without skewing;

FIG. 18 is a side view of a fifteenth switched reluctance motor with skewing; and,

FIG. 19 is a graph comparing torque ripple of the switched reluctance motors of FIGS. 17 and 18 compared to the torque ripple of a further switched reluctance motor.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing Patent Application, and the applicants, inventors or owners do not intend to abandon, disclaim, or dedicate to the public any such invention by its disclosure in this document.

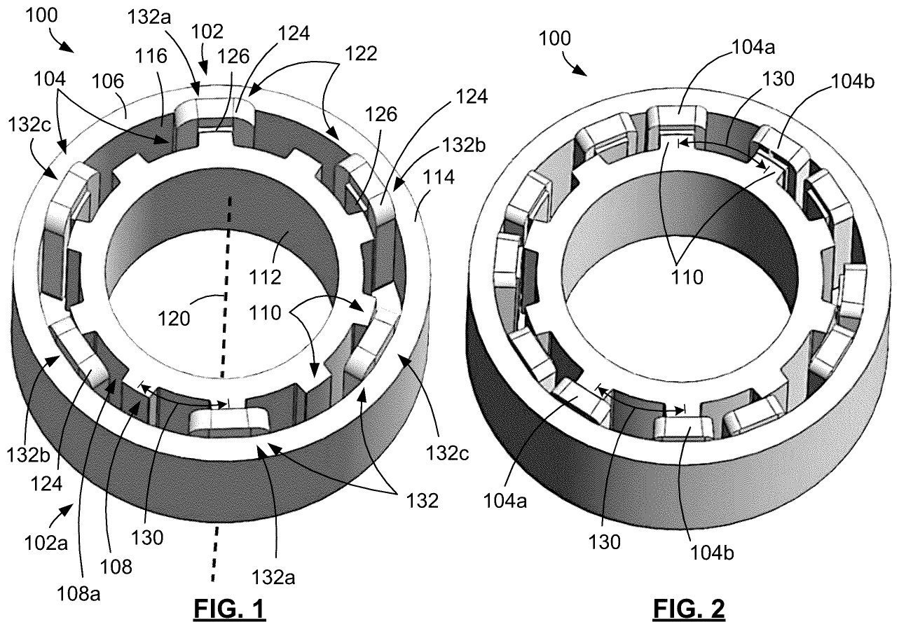

Referring to FIG. 1, illustrated is a switched reluctance motor 100. The switched reluctance motor 100 includes a first member 102 having a plurality of teeth 104 extending out from a back portion 106. The switched reluctance motor 100 also includes a second member 108 having a plurality of teeth 110 extending out from a back portion 112. The first member 102 and the second member 108 are mounted adjacent one another (e.g., in a position in which the teeth 104, 110 face one another across a small gap) allowing for relative movement between them. The teeth 104 of the first member 102 extend towards the teeth 110 of the second member 108. It will be appreciated that a moveable member of the motor (e.g., the second member 108) may be coupled to an external body in any suitable way (e.g., via a shaft mounted to the second member) to provide work from the motor 100.

As exemplified, the first member 102 may be a stator 102a. As exemplified, the back portion 106 of the first member 102 may be a generally cylindrical yoke 114 with the teeth 104 extending radially inwardly from an inner side 116 of the yoke 114. As exemplified, the second member 108 may be a rotor 108a rotatably mounted within the stator 102a. As exemplified, the rotor 108a may be rotatably mounted to rotate about a longitudinal axis 120 of the motor 100 and the teeth 110 may extend radially outwardly from the back portion 112 of the rotor 108a.

The exemplary motor of FIG. 1 is a rotary motor with the first member 102 (i.e., the stator in the illustrated embodiment) enclosing the second member 108 (i.e., the rotor in the illustrated embodiment). However, it will be appreciated that the first member 102 and the second member 108 may be any suitable first and second member mounted adjacent one another allowing for relative movement between. For example, the switched reluctance motor 100 may be, e.g., an ‘inverted’ motor (i.e., stator inside the rotor) or a linear motor. For an inverted motor, the first member 102 (i.e., the stator) may be enclosed by the second member 108 (i.e., the rotor). For a linear motor, the first member 102 and the second member 108 are each generally linear members, and one or both of the first and second linear members is mounted for bi-directional movement (e.g., reciprocating linear movement).

The first member 102 includes magnetic elements 122, such as windings. As exemplified, each tooth 104 of the first member 102 includes a winding 124 of electrically conductive material (e.g., copper or another metal). The winding 124 is wound around a core 126 of the tooth 104. The second member 108 is free of windings. It will be appreciated that the second member 108 may be moveably mounted relative to a frame supporting the first and second members in an adjacent relationship. The first member 102 may be fixedly mounted to the frame that is supporting the first and second members in the adjacent relationship. Including the magnetic elements 122 on the fixedly mounted member may, e.g., reduce the inertia of the moveably mounted member and/or simplify electrical pathways to the windings 124.

The first member 102 and the second member 108 are each formed of magnetically permeable material, such as steel or other metal. One or both of the first member 102 and the second member 108 may be formed of a stack of laminations, e.g., axially stacked whereby each lamination forms an axial portion of each tooth of the member.

The number of teeth 104 of the first member 102 is unequal to the number of teeth 110 of the second member 108. As exemplified, the first member 102 and the second member 108 may each have an even number of teeth, and the exemplary embodiment of FIG. 1 includes six stator teeth 104 and eight rotor teeth 110. However, it will be appreciated that various numbers of teeth may be used, and in some embodiments the first member and/or the second member may have an odd number of teeth.

The teeth 110 of the second member 108 are evenly spaced by a pitch 130. The pitch 130 is a tooth spacing that would be needed between the teeth 104 of the first member 102 for the teeth 104 of the first member 102 to line up with teeth 110 of the second member 108. Where the second member 108 is a rotor 108a, as exemplified in FIG. 1, the pitch 130 is an angle. However, it will be appreciated that the pitch 130 may be a fixed distance, such as where the motor is a linear motor and the first and second members are linear members.

It will be appreciated that the windings 124 are coupled to a power source (e.g., one or more batteries). Excitation of the windings magnetizes the first and second members, producing a torque causing the second member to move to align teeth 110 of the second member 108 with teeth 104 of the first member 102.

The teeth 104 of the first member 102 are arranged in a plurality of phase groups 132. As exemplified, the switched reluctance motor 100 may include a first phase group 132a, a second phase group 132b, a third phase group 132c, and optionally further phase groups. Each phase group 132 includes two teeth 104 and may include three or more teeth. The teeth 104 of a phase group 132 are coupled to the power source such that the windings 124 of the teeth 104 of a common phase group 132 are energized together. As exemplified in FIG. 1, the teeth of a common phase group may be separated from one another by a whole multiple of the pitch 130 (e.g., five times the pitch, as exemplified) such that each tooth 104 of the phase group 132 is aligned with a tooth 110 of the second member 108 at the same time. In a switched reluctance motor the second member 108 is induced to move relative to the first member 102 by sequentially energizing the phase groups 132 to cause the second member 108 to move, e.g., cause the rotor 108a to spin.

As exemplified in FIG. 2, the first member 102 may include additional teeth 104b. The number of additional teeth 104b per original tooth 104a could be one, two, or more than two. Each additional tooth 104b may be adjacent to an original tooth 104a, and part of the same phase group 132 as the adjacent original tooth 104a. In embodiments in which multiple additional teeth 104b are added per original tooth 104a, the multiple additional teeth 104b for each original tooth 104a may be adjacent one another between two original teeth and part of the same phase group 132 as an adjacent additional tooth 104b (i.e., if two additional teeth 104b are added next to one another and both between two original teeth 104a, the two additional teeth 104b may both be part of the same phase group 132 as one of the two original teeth 104a that they are between). As exemplified, adjacent teeth are teeth that are next to one other without intervening teeth. As exemplified, the additional teeth 104b may each be spaced by one pitch 130 from an adjacent original tooth 104a or by a whole multiple of one pitch 130. It will be appreciated that the spacing may be in either direction, e.g., for a rotational motor, as exemplified, this spacing may be clockwise or counterclockwise (i.e., an additional tooth 104b added in a clockwise position and/or in a counter clockwise position from the original tooth 104a).

Adding additional teeth enables distributing the number of turns of the windings for a phase over more teeth. The size (e.g., axial length) of the motor may thus be reduced. The size may be reduced particularly for motors with a low number of teeth on the first member, such as eight or less original teeth, or with six or less original teeth. The additional teeth may also, or alternatively, serve as paths for heat generated in the winding, with the additional teeth improving the thermal performance of the motor.

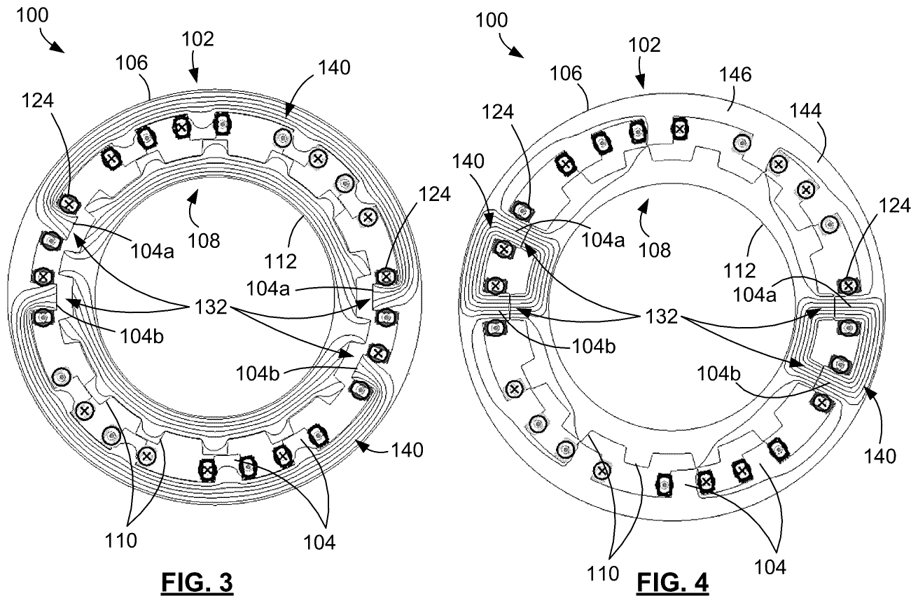

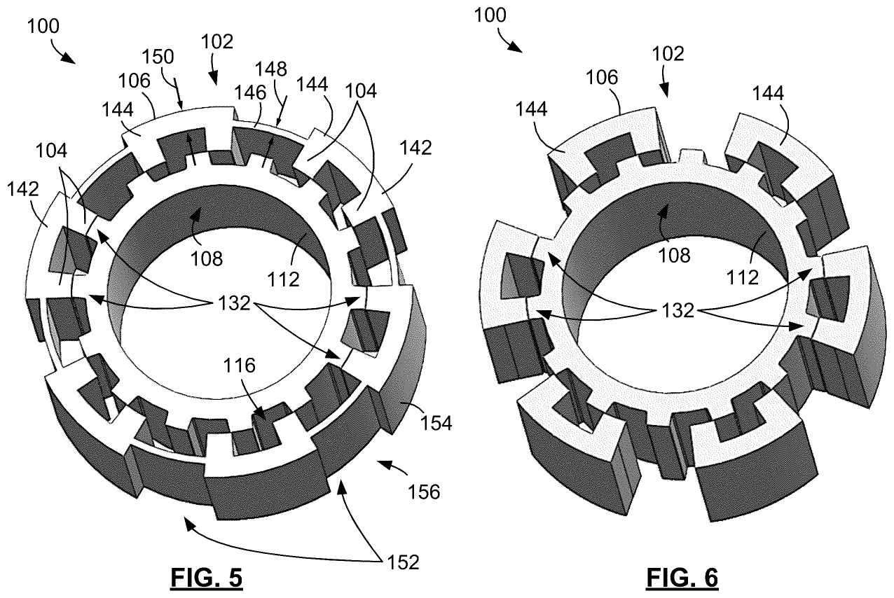

Referring now to FIGS. 3 and 4, the magnetic flux path 140 may be modified by controlling the direction of the excitation current in the windings 124. If the current direction in the winding 124 for an additional tooth 104b of a given phase 132 is the same as the current direction in the winding 124 of an adjacent original tooth 104a, the flux path 140 becomes long as shown in FIG. 3. If the current direction in the winding 124 for an additional tooth 104b of a given phase 132 is opposite the current direction in the winding 124 of an adjacent original tooth 104a, the flux path 140 becomes short as shown in FIG. 4.

Where the flux path 140 is short, sections of the back portion 106 have low magnetic flux density. In some embodiments, these sections of the first member may be made smaller than the remaining sections or removed altogether.

Referring now to FIGS. 5 and 6, each phase includes two teeth 104 of the first member mechanically joined together through a magnetically permeable bridge 142. The bridge 142 provides for a flux path through the first member 102. Where a phase 132 includes more than two teeth, the teeth may be arranged in one or more groups of two or more teeth, with the teeth of each group mechanically joined together through a magnetically permeable bridge. As exemplified, the teeth of a phase may be arranged in a plurality of pairs with each pair including two teeth mechanically joined together through a magnetically permeable bridge.

It is to be understood that references herein to a phase group including two adjacent teeth also include phase groups including more than two adjacent teeth such as three, four, or more adjacent teeth. It is also to be understood that where a phase group includes multiple adjacent teeth, additional teeth may utilize the same skewing factor and/or different skewing factors may be applied to different teeth in the phase group. As an example, if two additional teeth 104b are added next to an original tooth 104a, a first of the additional teeth 104b may be spaced by a whole multiple of the pitch plus or minus a first skewing factor and the second of the additional teeth 104b may be spaced by a whole multiple of the pitch plus or minus a second skewing factor that is different from the first skewing factor. As another example, if three additional teeth 104b are added next to an original tooth 104a, a first of the additional teeth 104b may be spaced by a whole multiple of the pitch plus or minus a first skewing factor, a second of the additional teeth 104b may be spaced by a whole multiple of the pitch plus or minus a second skewing factor that is different from the first skewing factor, and a third of the additional teeth 104b may be spaced by a whole multiple of the pitch plus or minus the first skewing factor, the second skewing factor, or a third skewing factor that is different from both the first and second skewing factors.

Where the first member 102 is arranged to have short flux paths 140 (e.g., adjacent windings coupled to the power source such that currents flow in opposite directions when energized), the portions of the back portion 106 of the first member 102 between the bridges 142 may be reduced in size as exemplified in FIG. 5 or removed altogether as exemplified in FIG. 6 to reduce the weight of the motor and increase the power density.

For a continuous back portion 106 (e.g., a circumferentially continuous yoke, as exemplified) of magnetically permeable material, as exemplified in FIGS. 4 and 5, the bridges 142 may be bridge segments 144 separated by intermediate segments 146. The intermediate segments 146 mechanically join the bridge segments 144 together. As exemplified in FIG. 4, the intermediate segments 146 may have generally the same size as the bridge segments 144. However, as exemplified in FIG. 5, the intermediate segments 146 may have a reduced size as compared to the bridge segments 144. As exemplified in FIG. 5, the intermediate segments 146 may have a reduced dimension along a direction in which the teeth 104 extend. For a rotational motor as exemplified in FIG. 5, the intermediate segments may have a first radial thickness 148 of magnetically permeable material and the bridge segments 144 may have a second radial thickness 150 of magnetically permeable material which is greater than the first radial thickness 148.

As exemplified in FIG. 5, the first member 102 may have recesses 152 in an outer surface 154 of a side 156 that is opposite the side 116 on which the teeth 104 are arranged. The inventors have discovered that having the intermediate segments closer to the windings to leave the recesses on the opposite side allows for more space across from the teeth to add fins or other features across from the teeth. For a rotational motor as exemplified in FIG. 5, the recesses 152 may be on a radial outer surface. The recesses 152 are provided between bridge segments 144. The recesses 152 result from the reduced size of the intermediate segments 146. It will be appreciated that, in some embodiments, the recesses 152 may be otherwise arranged, such as all on the same side as the teeth.

Referring now to FIG. 6, the areas of low flux density may be completely removed. As exemplified, the bridge segments 144 may be separated from one another. It will be appreciated that separate bridge segments 144 may be held in position relative to one another by a frame of the motor (e.g., a frame joining axial ends of the bridge segments). Alternatively, the bridge segments may be mechanically secured together in a continuous back portion 106 by a material that is lighter than the material used for the bridge segments, such as a material that is relatively not magnetically permeable (e.g., epoxy).

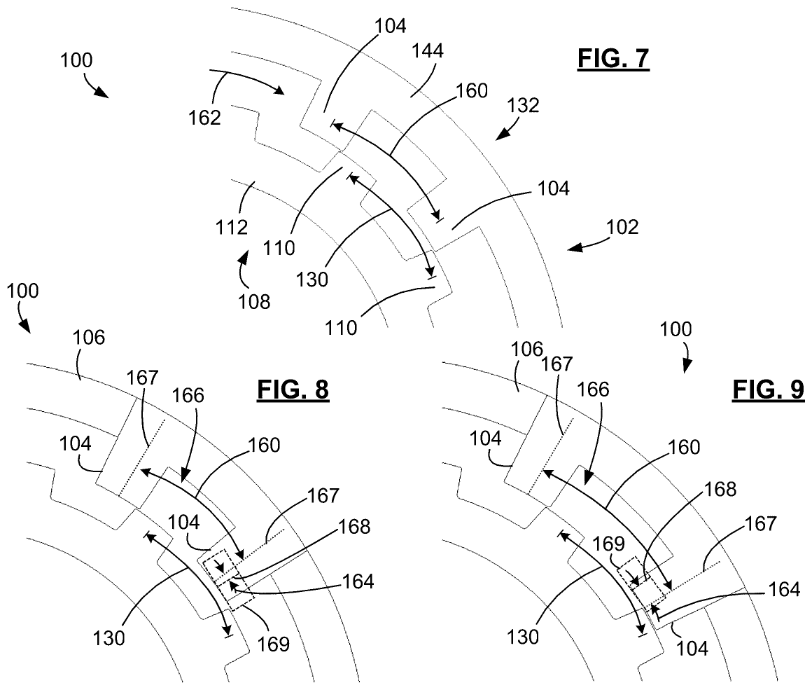

Referring now to FIG. 7, teeth 104 of a phase group 132 may be separated from one another by a spacing 160 that is generally equal to a whole multiple of the pitch 130 of the teeth 110 of the second member 108 (e.g., one times the pitch angle, as exemplified).

However, the inventors have discovered that in some embodiments skewing of the spacing 160 in the direction 162 of relative movement of the first and second members results in, e.g., a reduced phase resistance, improved efficiency, reduced current density, reduced motor weight, a reduced torque ripple, reduced, and/or greater flexibility in motor design.

Referring to FIGS. 8 and 9, the spacing 160 may be skewed by a skewing factor 164 such that the spacing 160 is equal to a whole multiple of the pitch 130 minus a skewing factor 164 (FIG. 8) or a whole multiple of the pitch 130 plus the skewing factor 164 (FIG. 9). As exemplified in FIGS. 8 and 9, the skewing factor 164 is the difference between the middle position 167 of the tooth 104 shown in solid lines and the middle position 168 of where the tooth would have been if it had not been skewed. FIGS. 8 and 9 each illustrate in a phantom tooth 169 where the tooth 104 would have been if it had not been skewed, and the middle position 168 is the middle position of the phantom tooth 169. For rotational motors as exemplified in FIGS. 8 and 9, the skewing is a circumferential skewing; the pitch 130 is a pitch angle, and the skewing factor 164 is a circumferential skewing angle.

The inventors have discovered that skewing teeth towards each other (e.g., as exemplified in FIG. 8) reduces the slot area 166 but may increase the amount of the back portion 106 that can be removed. This may reduce the motor weight and increase power density.

The inventors have discovered that skewing teeth away from one another (e.g., as exemplified in FIG. 9) may increase the slot area 166 between teeth and increase the winding area for the same fill factor. This may reduce the phase resistance, improve efficiency, and/or reduce current density.

The inventors have discovered that skewing direction and magnitude may be selected to reduce the torque ripple. Skewing may particularly reduce the torque ripple at high-speed operation where the control of the phase current is more limited.

Skewing may reduce the average torque at low speeds. However, the inventors have discovered that the torque reduction may be compensated for by adjusting the teeth geometry in addition to the drive turn-on and turn-off angles. While some embodiments do not include adjusted tooth geometry, some embodiments may include adjusted tooth geometry. Adjusted tooth geometry is discussed in more detail elsewhere herein.

The inventors have discovered that teeth belonging to the same phase do not have similar relative positions with respect to rotor teeth, and this may introduce more flexibility to the teeth design. It may also, or alternatively, allow discarding some constraints, such as the minimum pole arc angles for self-starting capability.

The skewing factor is tightly related to the application requirements, available space, motor geometry, and the objective of skewing. The skewing factor may be selected by investigating the contribution of the adjacent stator teeth to the phase torques. The tooth geometry and/or skewing factor may then be optimized to achieve the required objective functions within the given requirements and constraints.

In some embodiments, the skewing factor 164 is at least 0.01 times the pitch 130. In some embodiments, the skewing factor 164 is at least 0.05 times the pitch 130. In some embodiments, the skewing factor 164 is between 0.01 times the pitch and 0.25 times the pitch 130. In some embodiments, the skewing factor 164 is between 0.05 times the pitch and 0.15 times the pitch 130.

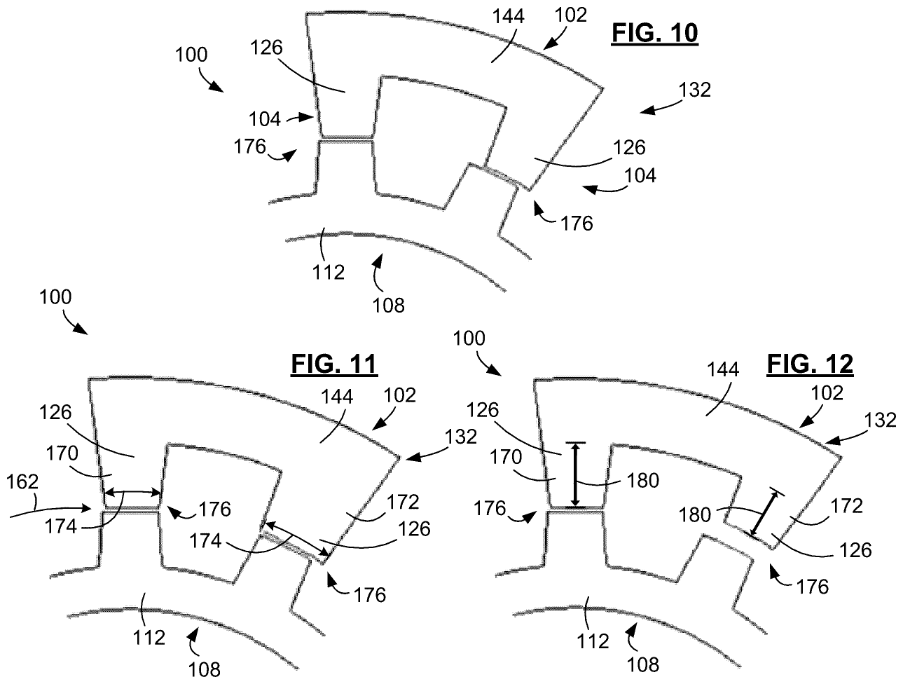

Referring now to FIGS. 10 to 12, in some embodiments a phase group 132 of the first member 102 includes teeth cores 126 of different geometries. As exemplified, the teeth cores 126 of differing geometries may be of adjacent teeth 104.

In some embodiments, the different geometries include a different width in a direction of relative movement of the first and second members (e.g., FIG. 11) and/or a different height of the teeth (e.g., FIG. 12).

As exemplified in FIG. 11, in some embodiments, the phase group 132 includes a first tooth 170 and a second tooth 172. Each tooth has a core with a width 174 in the direction 162 of relative movement between the first member 102 and the second member 108. As exemplified, for a rotational motor the width 174 may be a circumferential length of the inner end 176 of the tooth. The width 174 of an end 176 of the core of the first tooth 170 may be different from the width 174 of an end 176 of the core of the second tooth 172. The circumferential length of the end of the core of the second tooth 172 may be greater than the circumferential length of the end of the core of the first tooth 170, where the second tooth follows the first tooth in the direction 162 of rotation.

As exemplified in FIG. 12, each tooth core 126 has a height 180. Where the motor is a rotational motor, the height may be a radial extent, as exemplified. In some embodiments, the phase group 132 includes a first tooth 170 with a first height 180 and a second tooth 172 with a second height 180 that is less than the first height 180.

As exemplified in FIG. 13, each tooth core 126 has sides 182 facing toward and away from the direction 162 of relative motion of the first and second members. The sides 182 each form an angle 184 with an inner face 186 of the back portion 106. As exemplified, a tooth core 126 may have one or both sides 182 forming a negative taper angle 184 (i.e., angle 184 is less than 90 degrees). This may result in a trapezoidal geometry, as exemplified. A negative taper angle may assist in preventing the windings from slipping towards the free end of the tooth core 126.

In some embodiments, each phase group of the first member includes teeth of differing geometries. In some embodiments, each tooth of the first member of a motor is paired with another tooth of a different geometry. In some embodiments, each tooth of the first member is paired with another tooth of the same phase that is skewed in a direction of relative movement between the first and second members, and the tooth and the paired tooth have different geometries. As discussed elsewhere herein, different geometries may be selected along with skewing factors to achieve application requirements.

### EXAMPLES

The following non-limiting examples are illustrative of the present application.

For all simulations, the reference current was kept constant, and the turn-on and turn-off angles were optimized to maximize the average torque and minimize the torque ripple. The lamination geometry, skewing angle, and number of turns were not optimized. The purpose of the simulations was to show the effect of skewing in reducing the torque ripple.

### Example 1—Simulation of a 24/28 Switched Reluctance Motor

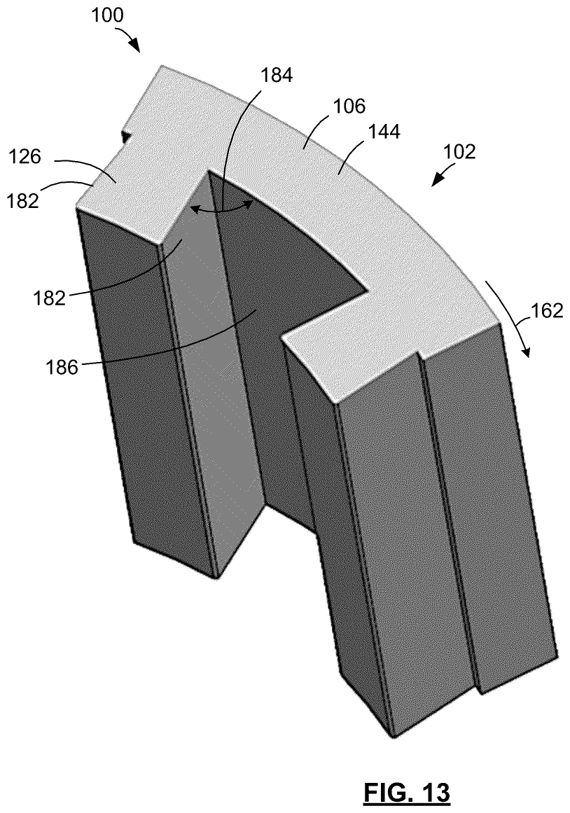

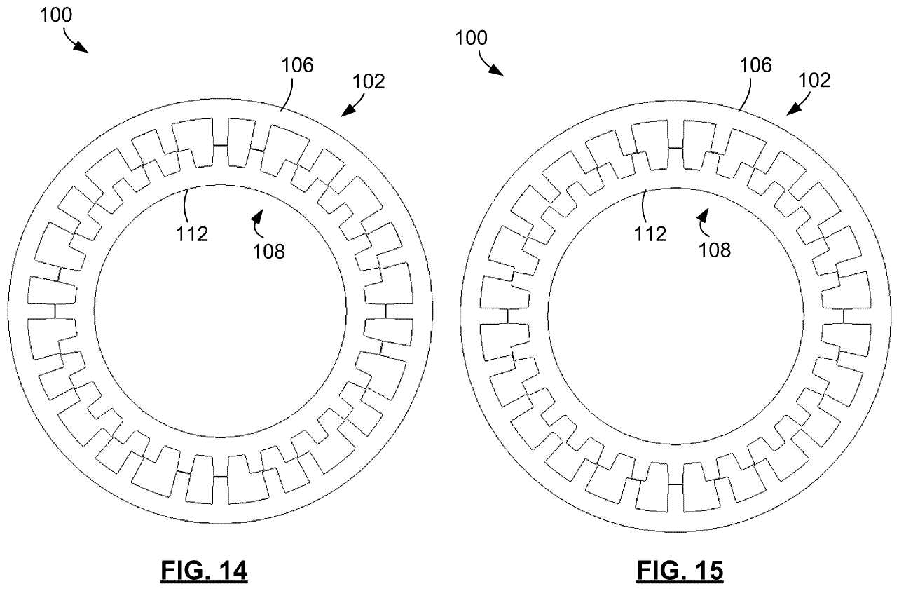

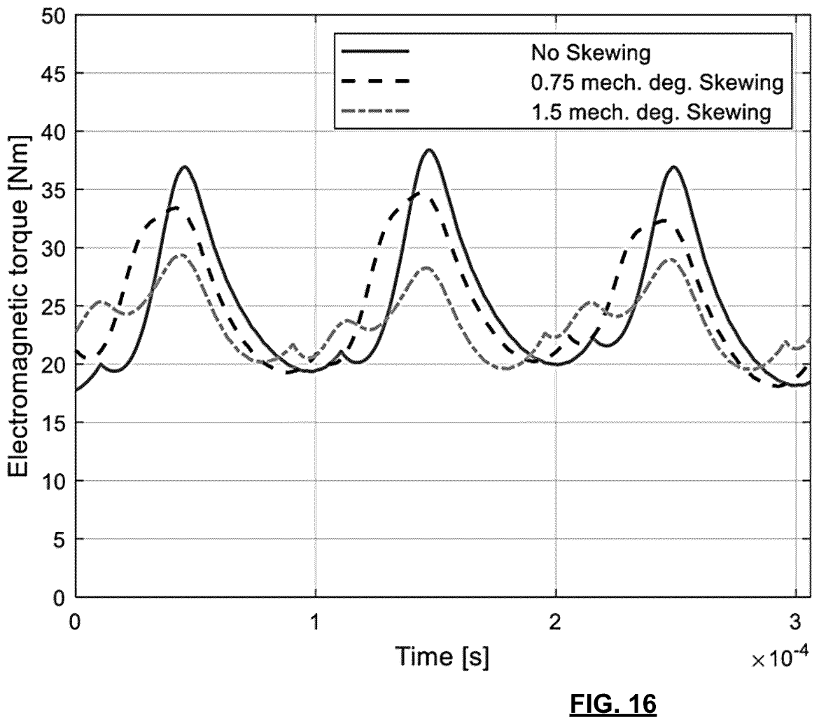

Referring to FIGS. 14 and 15, illustrated is a switched reluctance motor having 24 teeth on the first member and 28 teeth on the second member. The first member is a stator, and the second member is a rotor. FIG. 14 illustrates the 24/28 configuration without skewing. FIG. 15 illustrates the 24/28 configuration with a skewing factor of 1.5 mechanical degrees.

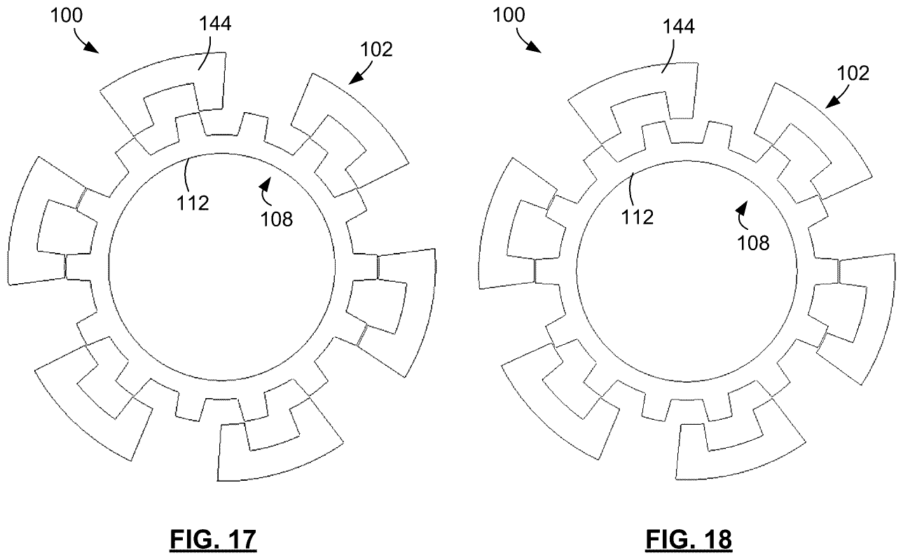

FIG. 16 illustrates simulation results, comparing no skewing to a skewing factor of 0.75 mechanical degrees and to a skewing factor of 1.5 mechanical degrees, each at 7,000 rpm. As exemplified in FIG. 16, the skewing affects the electromagnetic characteristics of the motor and results in significant reduction in the torque ripple at 7,000 rpm.

### Example 2—Simulation of a 12/14 Switched Reluctance Motor

Referring to FIGS. 17 and 18, illustrated is a switched reluctance motor having 12 teeth on the first member and 14 teeth on the second member. As exemplified, the back iron with low flux density is removed to achieve a modular design. FIG. 17 illustrates the 12/14 configuration without skewing. FIG. 18 illustrates the 12/14 configuration with a skewing factor of 2 mechanical degrees.

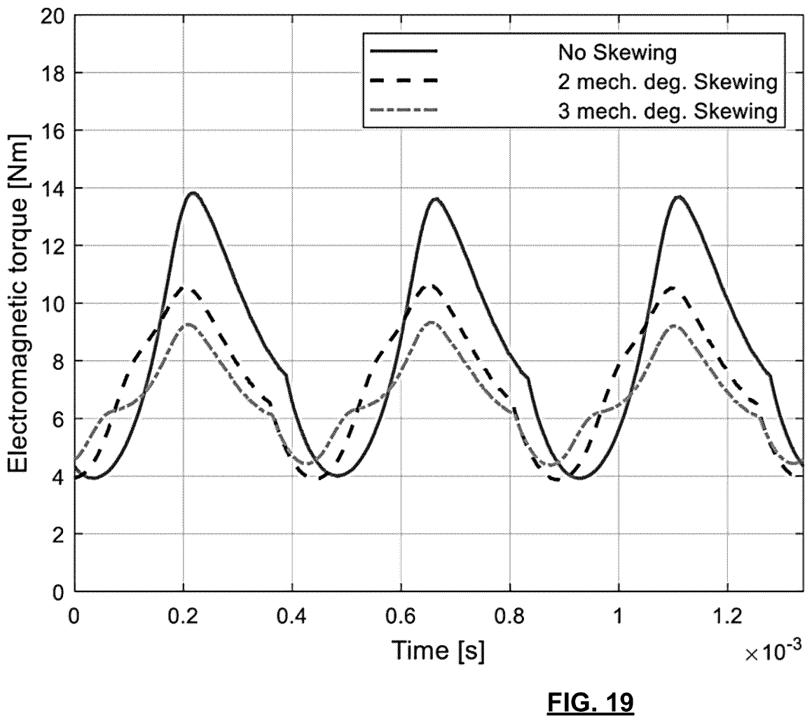

FIG. 19 illustrates simulation results, comparing no skewing to a skewing factor of 2 mechanical degrees and to a skewing factor of 3 mechanical degrees, each at 3,200 rpm. As exemplified in FIG. 19, a significant reduction of the torque ripple is achieved at 3,200 rpm when applying circumferential skewing.

What has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A switched reluctance motor, comprising:
a. a stator having a plurality of stator teeth arranged in a plurality of phase groups, each phase group including two adjacent teeth mechanically joined together through a magnetically permeable bridge; and
b. a rotor rotatably mounted within the stator and having a plurality of rotor teeth evenly spaced circumferentially by a pitch angle, and
wherein each phase group includes a first tooth and a second tooth separated from the first tooth by a separation angle in a direction of rotation of the rotor, the separation angle equal to the pitch angle plus a circumferential skewing angle or the pitch angle minus the circumferential skewing angle.

2. The switched reluctance motor of claim 1, wherein the circumferential skewing angle is between 0.01 times the pitch angle and 0.25 times the pitch angle.

3. The switched reluctance motor of claim 1, wherein the circumferential skewing angle is between 0.05 times the pitch angle and 0.15 times the pitch angle.

4. The switched reluctance motor of claim 1, wherein a tooth geometry of the first tooth is different from a tooth geometry of the second tooth.

5. The switched reluctance motor of claim 1, wherein the magnetically permeable bridges are bridge segments of a circumferentially continuous yoke of the stator and adjacent bridge segments are mechanically joined together by intermediate segments, the intermediate segments having a first radial thickness of magnetically permeable material and the bridge segments having a second radial thickness of magnetically permeable material, the second radial thickness being greater than the first radial thickness.

6. The switched reluctance motor of claim 5, wherein the yoke includes recesses on a radial outer surface between bridge segments.

7. A switched reluctance motor, comprising:
a. a first member having a plurality of teeth arranged in a plurality of phase groups, each phase group including two teeth mechanically joined together through a magnetically permeable bridge; and
b. a second member mounted adjacent the first member allowing relative movement between the first and second members, the second member having a plurality of teeth evenly spaced from one another by a pitch in a direction of relative movement between the first and second members, and
wherein each phase group includes a first tooth and a second tooth which is separated from the first tooth by a phase group tooth spacing in the direction of relative movement between the first and second members, the phase group tooth spacing equal to a whole multiple of the pitch plus a skewing factor or a whole multiple of the pitch minus the skewing factor.

8. The switched reluctance motor of claim 7, wherein the whole multiple is a single multiple and the first tooth and the second tooth are adjacent teeth.

9. The switched reluctance motor of claim 7, wherein the skewing factor is between 0.05 times the pitch and 0.15 times the pitch.

10. The switched reluctance motor of claim 7, wherein the skewing factor is between 0.01 times the pitch and 0.25 times the pitch.

11. The switched reluctance motor of claim 7, wherein the first member is a stator, and the second member is a rotor rotatably mounted within the stator.

12. The switched reluctance motor of claim 7, wherein each tooth of each phase group is part of a pair, the pair including another tooth separated by a whole multiple of the pitch plus a skewing factor or a whole multiple of the pitch minus the skewing factor.

13. The switched reluctance motor of claim 7, wherein the two teeth mechanically joined together through the magnetically permeable bridge includes the first tooth and the second tooth.

14. A switched reluctance motor, comprising:
a. a first member having a plurality of teeth arranged in a plurality of phase groups, each phase group including two teeth mechanically joined together through a magnetically permeable bridge; and
b. a second member mounted adjacent the first member allowing relative movement between the first and second members, the second member having a plurality of teeth evenly spaced from one another by a pitch in a direction of relative movement between the first and second members, and
wherein a phase group of the plurality of phase groups includes teeth of differing geometries.

15. The switched reluctance motor of claim 14, wherein the first member is a stator, and the second member is a rotor rotatably mounted within the stator, and the pitch is a rotor pitch angle.

16. The switched reluctance motor of claim 14, wherein each phase group includes teeth of differing geometries.

17. The switched reluctance motor of claim 14, wherein the teeth of differing geometries are adjacent teeth.

18. The switched reluctance motor of claim 14, wherein the phase group includes a first tooth and a second tooth, and a circumferential width of an inner end of a core of the first tooth is different from a circumferential width of an inner end of a core of the second tooth.

19. The switched reluctance motor of claim 18, wherein the circumferential width of the inner end of the core of the second tooth is greater than the circumferential width of the inner end of the core of the first tooth.

20. The switched reluctance motor of claim 14, wherein the phase group includes a first tooth with a core having a first radial extent and a second tooth with a core having a second radial extent that is greater than the first radial extent.

21. A switched reluctance motor, comprising:
a. a first member having a plurality of teeth extending from a first side of the first member, the plurality of teeth arranged in a plurality of phase groups, each phase group including two teeth mechanically joined together through a magnetically permeable bridge, the magnetically permeable bridges forming bridge segments of a continuous back portion of the first member, and adjacent bridge segments mechanically joined together by intermediate segments, and
b. a second member mounted adjacent the first member allowing relative movement between the first and second members, the second member having a plurality of teeth evenly spaced from one another by a pitch in a direction of relative movement between the first and second members, and
wherein the intermediate segments have a first thickness of magnetically permeable material and the bridge segments have a second thickness of magnetically permeable material, the second thickness being greater than the first thickness whereby a surface of the continuous back portion of the first member includes recesses between bridge segments, the recesses arranged at a second side of the first member opposite the first side from which the plurality of teeth extend.

22. The switched reluctance motor of claim 21, wherein the first member is a stator and the second member is a rotor rotatably mounted within the stator, and the continuous back member is a continuous yoke, and the first side of the first member is an inner side and the second side of the first member is an outer side.
